(19) United States
(12) Patent Application Publication
(10) Pub. No.: US 2006/0288786 A1
(43) Pub. Date: Dec. 28, 2006

(54) Ultrasonically coupled scanning probe microscope

(76) Inventors: Andres H. La Rosa Flores, Beaverton, OR (US); Richard Nordstrom, Hillsboro, OR (US); Xiquan Cui, Pasadena, CA (US)

Correspondence Address: KLARQUIST SPARKMAN, LLP, 121 SW SALMON STREET, SUITE 1600, PORTLAND, OR, 97204, US

(21) Appl. No.: 11/384,088

(22) Filed: Mar. 17, 2006

Related U.S. Application Data
(60) Provisional application No. 60/663,557, filed on Mar. 18, 2005.

(51) Int. Cl. G01N 29/26

(52) U.S. Cl. 73/618; 73/603; 73/602

(57) ABSTRACT

Scanning probe microscopes include a probe tip coupled to a tuning fork or other acoustic resonator so as to apply a shear force when contacted to a specimen surface based on an applied acoustic signal. A secondary ultrasonic transducer is in acoustic communication with the specimen. The probe tip and the secondary ultrasonic transducer are acoustically coupled when the probe tip is in proximity to a specimen surface. Changes in resonance frequency, admittance, or other characteristic of acoustic signals coupled to the probe tip or a secondary ultrasonic transducer secured to either the specimen or the probe tip can be used in specimen imaging or to estimate probe tip placement respect to a specimen surface.

### CROSS REFERENCE TO RELATED APPLICATIONS

This application claims priority from U.S. Provisional Patent Application No. 60/663,557, filed Mar. 18, 2005, and that is incorporated herein by reference.

### FIELD

The disclosure pertains to scanning probe microscopes.

### BACKGROUND

Scanning probe microscopes can be used for high resolution sample measurements. The lateral resolution of conventional optical microscopes is generally limited by diffraction effects, while in scanning probe microscope the resolution is limited by the dimensions of the scanning probe tip which is typically between about 5 nm and 100 nm. Some customary scanning probe microscopes include the atomic force microscope (AFM) and the near-field scanning optical microscope (NSOM). The AFM measures surface topographies by detecting a force exerted on a probe. In one configuration, a probe is secured to a cantilever, and deflections of the cantilever are estimated using laser beam illumination of the cantilever. The NSOM uses a probe having a small illumination aperture through which optical radiation is directed to a sample; and can be used to measure topographic and optical properties.

The AFM has been used to study frictional forces. A probe tip is dragged along a specimen surface and its lateral bending is monitored. This lateral bending is caused by frictional forces between the probe and the specimen. The smaller the bending experienced by the probe, the lower the frictional force. While such AFM-based measurements can provide useful insights into surface interactions, these measurements have significant limitations. For example, AFM-based measurements are associated only with frictional forces on the AFM probe, but provide no information on any effects on the sample, such as how energy is transferred to the sample by the probe. AFM-based measurements also provide limited information on any probe interactions with thin adsorbed fluid layers on specimen surfaces. Accordingly, methods and apparatus are needed that can provide enhanced specimen characterizations.

### SUMMARY

Scanning microscopes comprise a probe having a probe tip for contacting a specimen and a probe stage configured to move the probe tip toward the specimen. A first acoustic transducer is coupled to the probe or a probe mount and a second acoustic transducer is adapted to be acoustically coupled to the specimen. In some examples, a first transducer driver is configured to produce an acoustic vibration of the probe tip with the first acoustic transducer, and a first transducer detector is situated to receive an electrical signal produced by the second acoustic transducer in response to the acoustic vibration of the probe tip. In further examples, a translation stage is configured for scanning the probe tip with respect to a specimen surface, and an image processor is configured to receive electrical signals from the first transducer detector as the probe tip is scanned to produce an image of a specimen surface. In some particular examples, a quartz tuning fork includes the first acoustic transducer, wherein the probe tip is secured to a tine of the tuning fork. In additional examples, the first transducer detector is configured to detect probe tip vibration based on an assessment of a tuning fork vibration amplitude or resonance frequency shift. In other alternatives, the first transducer detector is configured to detect probe tip vibration based on an assessment of a tuning fork admittance or based on an assessment of a frequency associated with a maximum amplitude of a tuning fork vibration. In some examples, the first transducer detector is configured to detect a resonance frequency shift or other property of a probe tip oscillation, and an admittance can be estimated based on such oscillation properties.

In still further examples, a first transducer driver is configured to produce an acoustic vibration of the specimen with the second acoustic transducer, and a first transducer detector is situated to receive an electrical signal produced by the first acoustic transducer in response to the acoustic vibration of the specimen. In some examples, a translation stage is configured for scanning the probe tip with respect to a specimen surface, and an image processor is configured to receive electrical signals from the first transducer detector as the probe tip is scanned to produce an image of a specimen surface. In other representative embodiments, a quartz tuning fork includes the first acoustic transducer, wherein the probe tip is secured to a tine of the tuning fork, and the first transducer detector is configured to detect probe tip vibration based on an assessment of a tuning fork vibration amplitude, a tuning fork admittance, or a frequency or frequency shift associated with a maximum amplitude of a tuning fork vibration.

Methods comprise scanning a probe tip over a specimen surface and applying an acoustic signal to the specimen. The acoustic signal is coupled between the specimen and the probe tip, and the coupled acoustic signal is detected. An image is formed based on the detected coupled acoustic signal. In other examples, the acoustic signal is applied to the specimen with a transducer that is secured to the probe tip or the coupled acoustic signal is detected with an acoustic transducer that is secured to the probe tip. In other examples, the acoustic signal is applied to the specimen with a transducer that is secured to the specimen.

In other methods, an acoustic signal is applied to a probe tip and a probe tip distance from a specimen surface is estimated based on detecting an acoustic signal at the specimen. In a representative examples the method includes establishing that a probe tip oscillation remains substantially unchanged at the distance at which the acoustic signal from the specimen is detected.

The foregoing and other features and advantages of the disclosed technology will become more apparent from the following detailed description, which proceeds with reference to the accompanying figures.

### BRIEF DESCRIPTION OF THE DRAWINGS

FIG. 1 is a schematic diagram of a scanning probe microscope that includes an ultrasonic sensor.

FIG. 2A is a graph of a representative tuning fork admittance spectrum for probe-specimen approach.

FIG. 2B is a graph of a representative ultrasonic transducer spectrum for probe-specimen approach and corresponding to the tuning fork admittance spectrum of FIG. 2A.

FIG. 3 is a graph illustrating a fit of ultrasonic signal data to a signal model.

FIG. 4 is a graph illustrating ultrasonic signal magnitude as a function of tuning fork power dissipation.

FIGS. 5A-5C are graphs of a damping constant, a force gradient, and ultrasonic signal magnitudes as functions of probe tip/specimen separation, respectively.

FIGS. 6A-6B are graphs illustrating shear force and ultrasonic signal amplitudes as functions of probe-specimen displacement for a probe that is moved so as to approach a specimen (FIG. 6A) or for a probe that is retracted from a specimen (FIG. 6B).

FIG. 7 is a graph illustrating shear force and ultrasonic signal amplitudes as a function of probe-specimen displacement.

FIGS. 8A-8B are graphs of a tuning fork signal and an ultrasonic sensor signal as functions of frequency for various probe tip/specimen separations.

FIGS. 9A-9B are enlarged portions of the graphs of FIGS. 8A-8B.

FIG. 10 is a schematic diagram of a scanning probe microscope that illustrates placement of ultrasonic transducers.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” means electrically, electromagnetically, or acoustically connected or linked and does not exclude the presence of intermediate elements between the coupled items.

The described systems, apparatus, and methods described herein should not be construed as limiting in any way. Instead, the present disclosure is directed toward all novel and nonobvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Representative methods and apparatus are described herein that are associated with scanning probe microscopes. In one representative example, a so-called Ultrasonic/Shear-Force Microscope (USFM) is described which can be used as, for example, an analytical tool to investigate the dynamics displayed by fluid-like films when subjected to mesoscopic confinement. In the disclosed examples, one or more acoustic transducers can be provided to apply or detect acoustic signals on a specimen. In some examples disclosed herein, ultrasonic signals are applied or detected. For convenience, acoustic signals having a frequency of at least about 20 kHz are referred to as ultrasonic, while acoustic signals having frequencies greater than about 10 Hz can be used.

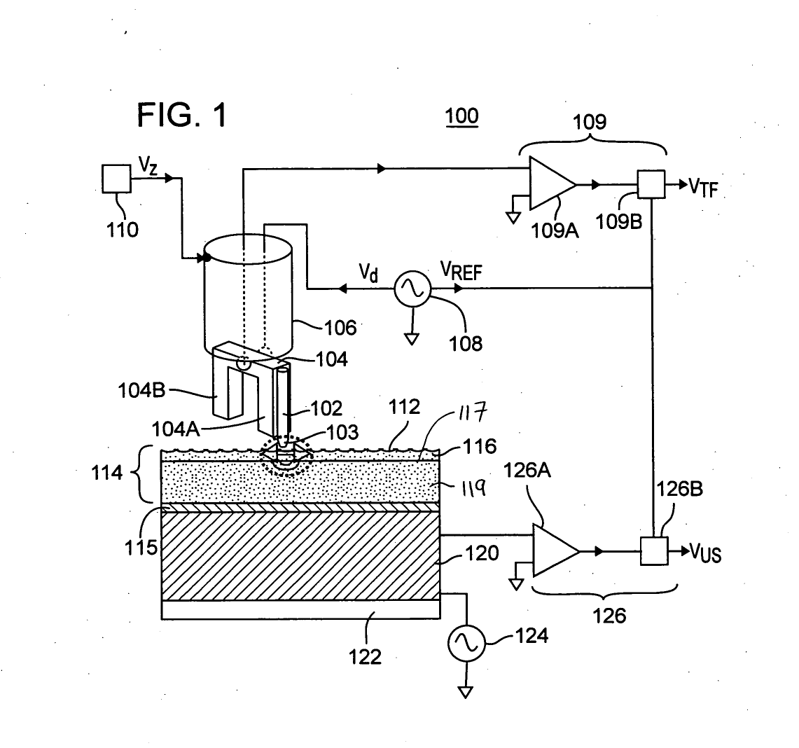

Referring to FIG. 1, a representative USFM 100 includes a probe 102 coupled to an quartz tuning fork 104 and a piezoelectric stage 106. The quartz tuning fork 104 includes first and second tines 104A, 104B and is configured to oscillate at a selected frequency, typically between about 1 kHz and 500 kHz and can have a quality factor (Q) of between about 1,000 and 50,000. The tuning fork 104 is electrically coupled to tuning fork driver 108 and to a detection system 109 that includes a preamplifier 109A and a lock-in amplifier 109B. The tuning fork driver 108 is generally configured to provide an electrical signal to the tuning fork 104 so that displacements of the tines 104A, 104B are in range of up to about 1-50 nm, but tine displacements of about 1-10 nm are convenient.

A stage controller 110 is configured to supply an electrical signal to the piezoelectric stage 106 to control the vertical displacement of a probe tip 103 from a specimen 114. In some examples, the piezoelectric stage controller 110 uses a feedback-based control scheme to compensate piezoelectric stage properties such as stage hysteresis for accurate and repeatable probe tip placement. As shown in FIG. 1, vertical displacements are associate with probe-specimen separations, while translations in a horizontal plane can be used in scanning to obtain specimen images. This arrangement is used for convenience, and other orientations can be used.

As shown in FIG. 1, a specimen 114 includes an adsorbed fluid layer 116 that defines a specimen surface 112. This adsorbed fluid layer 116 can also be referred to as a contaminant layer, and generally the probe 102 contacts a surface such as the surface 112 prior to contacting a surface 117 of an underlying specimen body 119. The surface 117 can also be referred to as a solid surface as it is the surface of the (usually) solid specimen 114. The specimen 114 is in contact with an ultrasonic transducer 120 via an acoustic coupling medium 115 and is supported by a specimen stage 122. The ultrasonic transducer 120 can be coupled to an ultrasonic signal generator 124 and an ultrasonic signal detector 126 that includes a preamplifier 126A and a lock-in amplifier 126B. The lock-in amplifiers 109B, 126B are both coupled to the tuning fork driver 108 for phase sensitive detection of electrical signals received from the tuning fork 104 and the ultrasonic transducer 120, respectively. Other methods and apparatus can be used as convenient. The specimen stage 122 and/or the piezoelectric stage 106 are generally secured to a two-axis scanning stage so that the probe tip 103 can be laterally scanned over the specimen surface 112. A tuning fork signal V_{TF} and/or an ultrasonic sensor signal V_{US} can be acquired during scanning, and processed to form images.

In operation, the tuning fork (TF) 104 is activated by the driver 108 and is moved towards the specimen surface 117 until an interaction of the probe tip 103 with the specimen 114 is detected. Typically, a probe/specimen interaction is detected based on a decrease in amplitude and a shift in the resonance frequency of the tuning fork 104 determined by detection system 109. Alternatively, a probe/specimen interaction can be detected based on an acoustic signal excited by an ultrasonic sensor and detected at a tuning fork or other acoustic sensor. By scanning the probe tip 103 across the specimen surface 117 and measuring TF resonance frequency shifts or other changes in TF response, a one or two dimensional representation of the surface 117 can be produced. As shown below, the probe tip 103 is also responsive to the layer 116. An electrical signal associated with the specimen interaction is output by the lock-in amplifier 109B. A shift in a resonance frequency in a tuning fork is a convenient technique for detecting probe/specimen interactions, but other techniques, such as, for example, measurement of laser beam deflection can be used. Because tuning fork based techniques are associated with low power dissipation, they are particularly useful for low temperature operation, but in some examples, probes can be secured to cantilevers instead of tuning forks.

The probe tip 103 can be configured to enhance or select a particular surface interaction. For example, a silicon based probe can be provided with a magnetic tip coating such as, for example, a cobalt alloy coating, for Magnetic Force Microscopy (MFM) or a conductive coating for Scanning Tunneling Microscopy (STM).

The stage ultrasonic transducer 120 can be configured to detect ultrasonic signals propagating in the specimen 114 or specimen stage 122 and associated with interactions of the probe tip 103 and the specimen 114. A detected output signal V_{US} associated with the ultrasonic signal at the specimen or specimen stage is output by the lock-in 126B. This signal can be used to produce a two dimensional image of the specimen 112 in the same manner as a detected frequency shift or change in Q of the tuning fork 104.

In representative examples, a polished silicon wafer is used as the specimen. The probe is a tapered optical fiber (3M fiber FS-SC-6324) fabricated by using a tube etching method which produces a probe tip having a radius of about 30 nm. Such methods are described in, for example, Stöckle et al., “High-quality near-field optical probes by tube etching,” Appl. Phys. Lett. 75:160-162 (1999). The probe is attached to a commercially available 2¹⁵ Hz tuning fork which can serve to apply and sense a lateral (shear) force. Because of the additional mass and internal friction associated with attachment of the probe to the tuning fork (typically, the fiber is glued to the tuning fork), the resonant frequency of the tuning fork shifts to a lower frequency. In one example, the resonant frequent shifts to about 31,283 Hz and the tuning fork Q decreases to about 10³.

In operation, the TF can be driven by a constant amplitude AC voltage V_{d} supplied or controlled by the signal generator 108. A constant voltage amplitude TF drive corresponds to a constant force drive. Probe/specimen displacement is controlled using a piezo tube actuator such as an EBL 3 actuator available from Staveley Sensor Inc. Such an actuator has a sensitivity of about 20 nm/V and can be controlled with a variable DC voltage V_{z}. An SE35-Q ultrasonic sensor (available from Dunegan Engineering Consultants, Inc) can serve as the ultrasonic sensor. A layer of vacuum grease can be used between the specimen and the ultrasonic sensor to increase the efficiency of ultrasound transmission. The ultrasonic signal can be detected by the lock-in amplifier 126B. The signal used to drive the tuning fork can be used as a reference signal for the amplifiers 109A, 126A.

As the probe tip approaches the specimen, the resonant frequency and the damping rate (Q) of the tuning fork are changed by conservative and dissipative probe-specimen interactions, respectively. To evaluate the probe-specimen interaction at different heights, the frequency spectrum of the TF admittance is measured using the detection system 109. Using an equivalent electrical circuit model, the resonant frequency and the damping rate change can be estimated by fitting the admittance data as described in, for example, Karrai and Tiemann, “Interfacial shear force microscopy,” Phys. Rev. B 62:13174 (2000).

The motion of TF can be described by the Newton equation:
M\ddot{x}=F_{drive}+F_{damp}+Fᵣₑₛₜₒᵣₑ=F_{drive}−Mγ₀\dot{x}−k₀x, (1)
wherein x is the displacement of the TF vibration, F_{damp} is a damping force, Fᵣₑₛₜₒᵣₑ is a restoring force due to the TF's elastic deformation, M is an effective mass, γ₀ is a damping rate of the free TF in air, and k₀ is a TF spring constant.

Dissipative and conservative probe-sample interactions and associated forces, F_{dissipate} and F_{conserve}, respectively, can contribute to tuning fork motion as follows:

$$\begin{matrix}M \ddot{x} = {F}_{drive} + {F}_{damp} + {F}_{dissipate} + {F}_{restore} + {F}_{conserve} \\ = {F}_{drive} - M ( {γ}_{0} + {γ}^{′} ) \dot{x} - ( {k}_{0} + {k}^{′} ) x \\ = {F}_{drive} - M γ \dot{x} - kx\end{matrix} \qquad ( 2 )$$

wherein γ is an effective damping rate due to the dissipative interaction and k′ is a force gradient due to the conservative interaction. The time averaged power dissipated in the velocity dependent dissipative interaction −Mγ′\dot{x} is negative, and the time averaged power of the displacement dependent conservative interaction −k′x is zero. γ is a total damping rate, and k is a total restoring force gradient.

The electrical response of the TF can be linked to a mechanical response model based on a piezo-electro-mechanical coupling constant α as follows:

$$L \ddot{Q} + R \dot{Q} + \frac{1}{C} Q = {V}_{d} , \\ wherein Q = 2 α x , \\ L = M / 2 {α}^{2} , \\ R = M γ / 2 {α}^{2} , \\ 1 / C = k / 2 {α}^{2} , \\ and {V}_{d} = {F}_{drive} / α . \qquad ( 3 )$$

(Note that Q is also used sometimes herein to refer to resonator quality factor). Because of a parallel capacitance Cₚ of the TF, an electrical admittance of the TF is:

$$Y ( ω ) = \frac{1}{R + ⅈ ω L + \frac{1}{ⅈ ω C}} + ⅈ ω {C}_{p} . \qquad ( 4 )$$

By fitting measured data to the above model formula, the admittance of the TF and values for L, R, C, Cₚ can be estimated. In one example, dimensions of the TF tines (length, width, height, respectively) are l=4 mm, t=0.6 mm, and w=0.33 mm, so that k_{bareTF}=(E/4)w(t/L)³=22×10³ N/m. For the bare TF in an ambient environment, C=1.135×10⁻¹⁴ F. Thus, using the equation 1/C=k/2α², the piezo-electro-mechanical coupling constant α of the TF in this example is about α=11×10⁻⁶ C/m.

In steady state TF oscillation, the time averaged power consumed by the dissipative probe-sample interaction can be calculated by the mechanical model and the equivalent circuit model separately as

$${P}_{dissipate} = - \frac{2 {( {F}_{drive}^{RMS} )}^{2} {γ}^{′}}{M [ {( \frac{{ω}_{0}^{2}}{ω} - ω )}^{2} + {γ}^{2} ]} = - \frac{{( {V}_{d}^{RMS} )}^{2} ( R - {R}_{0} )}{{{L}^{2} ( \frac{{ω}_{0}^{2}}{ω} - ω )}^{2} + {R}^{2}} , \qquad ( 5 )$$

wherein R₀ is the equivalent resistance of the TF when it is far away from the probe-sample interaction region. The dissipative power has a peak at the resonant frequency ω₀²=k/M=1/(LC). TF driving voltages of about 60 mV, 30 mV, 14 mV, and 6 mV are used, and correspond to drive forces of about 660 nN, 330 nN, 154 nN, and 66 nN, respectively. Approximately the same TF admittance change was obtained for each of these drive voltages.

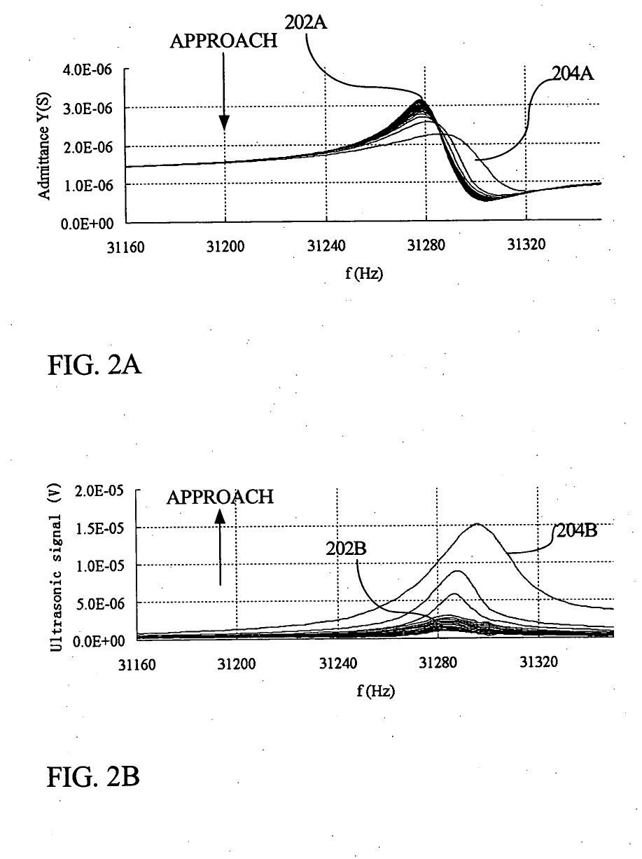

FIG. 2A illustrates a TF admittance spectrum at a 60 mV drive voltage with the probe tip moved to approach the specimen. An initial spectrum 202A corresponding to the probe being substantially distant from the specimen changes into a subsequent spectrum 204A as the probe tip approaches the specimen. The closer the probe tip is to the sample, the stronger the probe-sample interaction. The dissipative interaction, corresponding to a damping of the admittance spectrum, increases monotonically. The conservative interaction corresponding to a frequency shift of the admittance spectrum does not change appreciably during the initial movement towards the specimen, but exhibits substantial changes at short probe-sample distances. When the probe tip 103 contacts the sample, the TF admittance curve is distorted. Before contact, the TF admittance curves can be fitted based on the model of Eqn. 4. For this reason, contact is can be identified based on a transition to a distorted TF admittance curve, and the displacement at this transition can be referred to as z=0 nm.

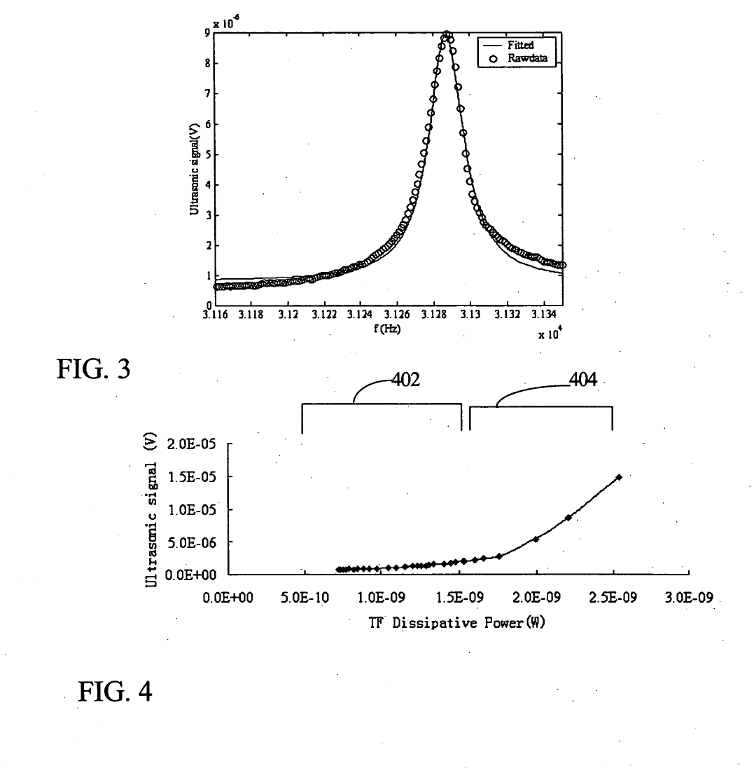

FIG. 2B illustrates spectra obtained with the ultrasonic transducer as the probe tip approaches the sample. The spectra of FIG. 2B correspond to those of FIG. 2A and were obtained at the same time with the same 60 mV drive voltage. FIG. 2B illustrates spectra obtained with the ultrasonic transducer as the probe tip approaches the sample. The ultrasonic spectra exhibit similar behavior at different drive voltages, but signal magnitudes depend on drive voltage. Curve fitting of the ultrasonic spectra show that the ultrasonic signal peaks correspond to the TF resonant frequencies ω₀=1/\sqrt{LC} (which corresponding to the peaks of the TF dissipative power). By choosing a proper scaling factor, the ultrasonic signal can be shown to substantially overlap the TF dissipative power model of Eqn. 5. FIG. 3 is an example of such an overlap for a probe-sample distance z≈0.5 nm.

FIG. 4 illustrates an increasing ultrasonic signal amplitude as a function of increasing TF dissipative power at the resonant frequency as the probe approaches the specimen with the TF drive voltage at 60 mV. Viewing FIG. 4, two distinct regions 402, 404 for ultrasound generation can be observed, with a transition at a probe-specimen separation of about z≈1 nm. When the probe-specimen distance is greater than about 1 nm, ultrasound generation is proportional to TF dissipative power with a first slope. When the probe-sample distance is smaller than about 1 nm, ultrasound generation is also proportional to TF dissipative power but with a second slope that is greater than the first slope. These two distinct ultrasound generation regions suggest that there are two different types of probe-sample interactions. After the above measurements, the resonant frequency of the free TF was unchanged.

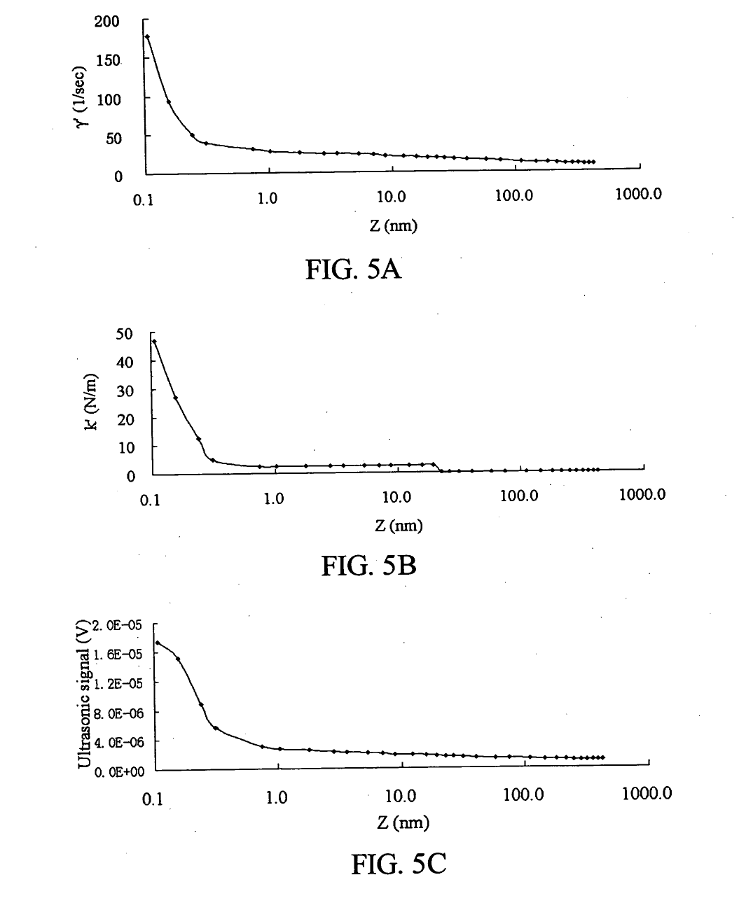

FIGS. 5A-5C illustrate effective damping rate, force gradient, and ultrasonic signal change as a function of probe-specimen distance z at a 60 mV tuning fork drive voltage. The probe-specimen separation at which distortion of the TF admittance spectrum is observed is taken to be the sample surface (i.e., z=0 nm).

There are two different regions of the probe-sample interaction can be observed in FIGS. 5A-5C. When the probe is several hundred nanometers away from the sample, the damping rate increases linearly as the probe-sample distance z decreases. The force gradient and the ultrasonic signal do not change appreciably. The probe-sample interaction in this region is largely dissipative and there is no reactive interaction involved. The presence of a contamination layer (water or hydrocarbon compound layer) accounts for the viscous dissipation, because the viscous force due to the air layer between the probe and the sample is very small, on the order of 10⁻¹³˜10⁻¹⁵ N. When the probe-sample distance is less than 1 nm, the damping rate of the TF, the force gradient, and the ultrasonic signal increase dramatically.

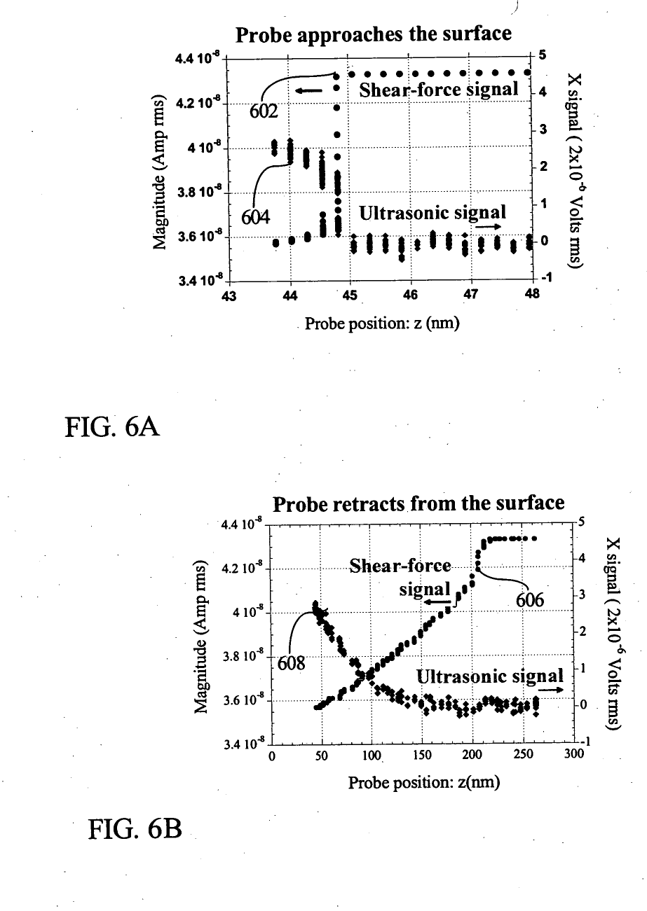

FIGS. 6A-6B illustrate signals obtained with the tuning fork 104 and the ultrasonic transducer 120 as the probe tip 103 is moved towards or away from the specimen surface 17. In FIG. 6A, as the probe tip approaches the specimen surface 117 (i.e., as z is decreased), a shear force signal 602 decreases abruptly (at a relative displacement z of about 44.8 μm), indicating that the probe tip is contacting the specimen surface 112. The ultrasonic signal also changes abruptly. After reaching the position at which the tuning fork 104 is indicated as contacting the specimen 114, both the tuning fork signal and the ultrasonic signal remain relatively constant with respect to further tuning fork displacements towards the specimen. Thus, FIG. 6A shows that the approach of the probe tip 103 to the specimen can be detected so as to anticipate subsequent probe contact, providing a sensitive indicator for use in probe positioning. In addition, the ultrasonic signal is associated with interaction of the probe tip and a fluid layer on the specimen.

Referring to FIG. 6B, as the probe tip is withdrawn from the specimen (i.e, as z is increased), a tuning fork signal 606 (a shear force signal) changes somewhat gradually until the relative displacement z is about 210 nm. At this displacement, the tuning fork signal 606 increases abruptly. In contrast, an ultrasonic transducer signal 608 exhibits a noticeable change only at a displacement of about z=150 nm, and does not exhibit an abrupt signal behavior expected for the transition from probe contact to noncontact.

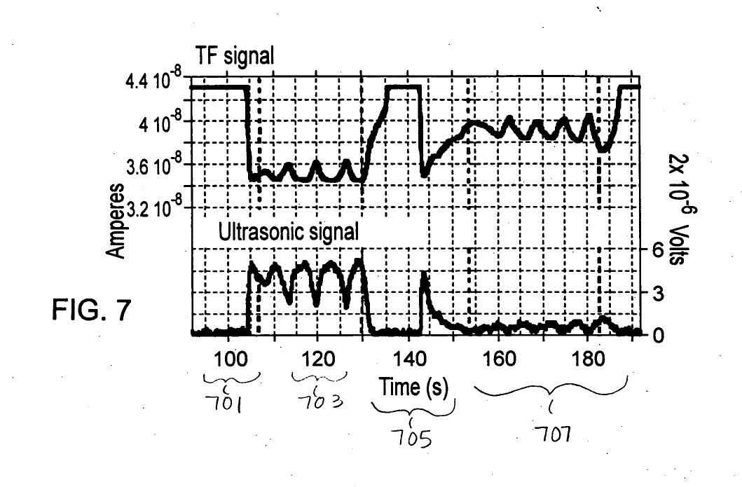

Referring to FIG. 7, a TF signal magnitude and ultrasonic sensor signal magnitudes are graphed as a function of time as a probe tip is moved towards and away from a glass sample. The probe tip is advanced toward the specimen in an interval 701 in which both signals remain substantially constant until a layer boundary is reached near the end of the interval 701. At this displacement, the TF signal decreases and the ultrasonic signal increases. The observed increased intensity of the ultrasonic signal as specimen/probe tip distance is reduced can be ascribed to a distance dependence of the adsorbed layer's viscoelastic properties, but this explanation may require that a viscoelastic coefficient for a water film (the adsorbed layer) that is much larger than a value for a bulk sample. A high viscoelasticity of the adsorbed layer acts can serve as an amplifier of acoustic waves generated by a laterally oscillating probe tip. During an interval 703, the probe is moved both toward and away from the specimen, and increases in the TF signal are associated with decreases in the ultrasonic signal. During this interval, the probe appears to be in contact with an adsorbed surface layer. In an interval 705, the probe tip is gradually retrieved from the surface (so that there is no hard contact between the probe tip and the specimen surface), but a clear ultrasonic signal is detected, demonstrating that an ultrasonic signal can be generated in the adsorbed layer. Finally, during an interval 707, the probe tip is moved toward and away from the specimen in a manner similar to that of the interval 703, but at a greater distance. Amplitude changes in the TF signal produce smaller changes in the ultrasonic signal than in the interval 703.

The “negative” correlation between the TF and ultrasonic signals (that is, one decreases while the other increases, and vice versa), is a common behavior observed with different types of samples such as glass, atomically flat mica, silicon wafers, and stainless steel, with thicknesses from less than about 1 mm up to about 5 mm. In some cases, however, a positive correlation is observed.

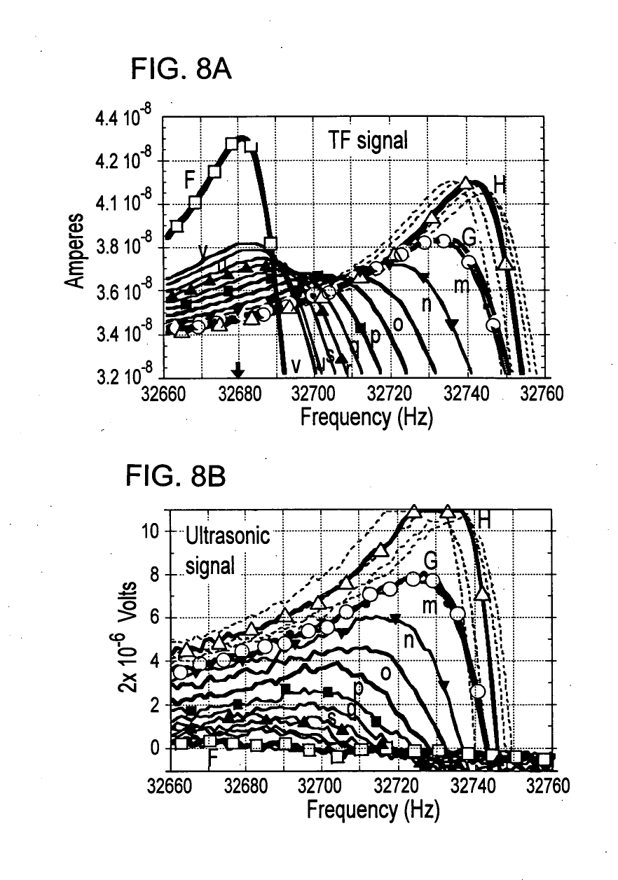

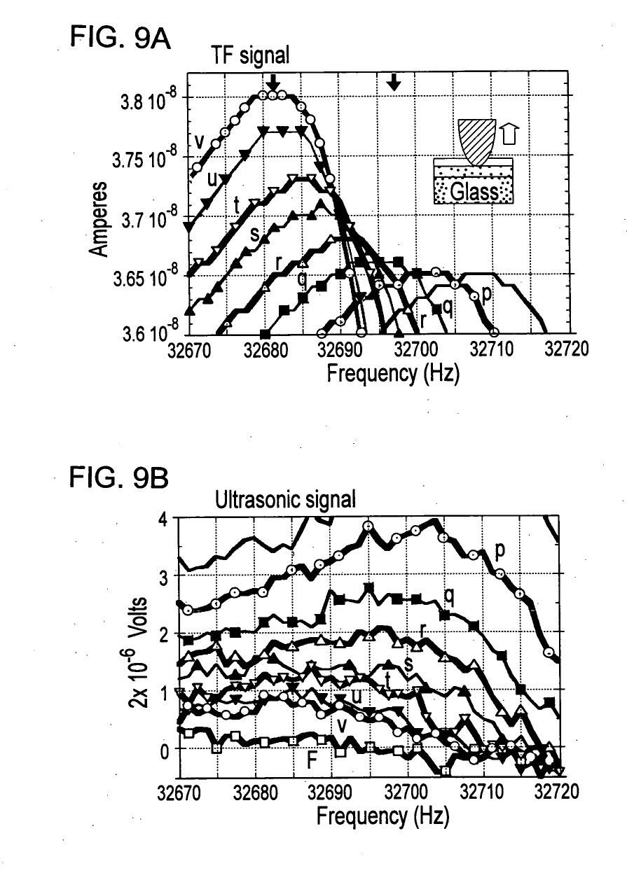

FIGS. 8A-9B illustrate representative measurements that include signals from the tuning fork and the ultrasonic sensor. FIGS. 9A-9B represent enlarged portions of FIGS. 8A-8B. FIG. 8A shows tuning fork signal spectra taken at different probe-sample distances, starting with the probe tip positioned distant from the sample (curve F), while approaching the sample (curves G and H), and during a gradual retraction (curves m to v, in alphabetic order). Corresponding ultrasonic signals are shown in FIG. 9A. The TF signals shown in FIG. 9A are based on a magnitude of an rms value of an ac current supplied by the TF and the ultrasonic signal is associated with an output of the ultrasonic transducer as processed by a lock-in amplifier. During the approach of the probe tip to the specimen, it can be difficult to acquire stable spectra just after the probe encounters an adsorbed layer. In FIGS. 9A-9B. curve G corresponds to a probe tip immersed into the adsorbed (contamination) layer, and likely in contact with a surface of the specimen. Moving the probe tip further toward the specimen (curve H) causes a further increase of the TF signal rather than a signal decrease that would be expected if the probe tip were immersed only in the adsorbed layer.

After the probe tip appears to have contacted a solid surface (curve H), further movement of the probe tip to the sample does not generally produce an increase in TF signal amplitude. In addition, slightly different z-axis control voltages produce frequency response curves (shown as dashed lines) situated about the curve H without appreciable resonance frequency shifts. Thus, the probe tip signal appears to correspond to clamping of the probe tip to the sample. However, even with the probe tip clamped in this manner, ultrasonic signal magnitude can vary considerably as can be noted in the dashed line curves of FIG. 8B.

The TF signal exhibits different behaviors for displacements on either side of a displacement associated with curve q, and, for convenience, the curve q displacement can be defined as a z=0 reference as a displacement at which the probe tip stops making solid-solid contact with the specimen surface during retraction. A frequency shift of 15 Hz in the ultrasonic signal is observed between spectrum q and spectrum v (an additional probe tip retraction of about 80 nm). Notice also that the intensity of the ultrasonic signal varies with the frequency shift; the greater the resonant frequency shift, the greater the ultrasonic signal Thus, the adsorbed layer is associated with both a damping force and an elastic restoring force.

Scanning probe microscopes that sense acoustic or ultrasonic signals in a specimen such as described above are well suited for analysis and evaluation of a wide variety of specimens. For example, nanofluid channels or devices can be characterized. Coupling and propagation of acoustic waves into the specimen by a scanning probe tip can be used to investigate subsurface specimen properties, such as cavities configured as nanofluid channels.

In view of the many possible embodiments to which the principles of the disclosed technology may be applied, it should be recognized that the illustrated embodiments are only preferred examples and should not be taken as limiting the scope of the technology. For example, various types of acoustic transducers can be used to apply and/or detect acoustic or ultrasonic signals. Piezo-electric transducers are convenient. These transducers can be configured as resonant mechanical structures such as tuning forks or other acoustic resonators. Alternatively, a driver or detection circuit can be coupled with an acoustic transducer to produce a resonant device based on the transducer/circuit combination. Detected signals can be processed with narrowband, phase sensitive circuitry, or frequency shifts, changes is admittance spectra, or changes in Q can be otherwise detected. For convenience, piezo-electric transducers in stage translators used to position the probe tip to contact a specimen or for scanning in image formation can be used to detect or apply acoustic signals as well.

As described in the above examples, an ultrasonic transducer is configured to detect acoustic signals produced by an oscillating tuning fork. In other examples, the ultrasonic transducer can be used to produce an acoustic wave or other acoustic vibration that is coupled to a probe configuration such as that of FIG. 1. In addition, one or more ultrasonic transducers can be situated on an upper surface (such as the surface 119) of a specimen, or secured to a translation stage used to position either the probe or the specimen. A transducer can be acoustically coupled to the same side of the specimen contacted by the probe tip. Several such transducers can be used to apply acoustic signals, or to detect acoustic signals for assessing probe location or for use in image formation. Acoustic transducers are generally located so as to be acoustically coupled to a probe tip, wherein the coupling is a function of probe/specimen displacement.

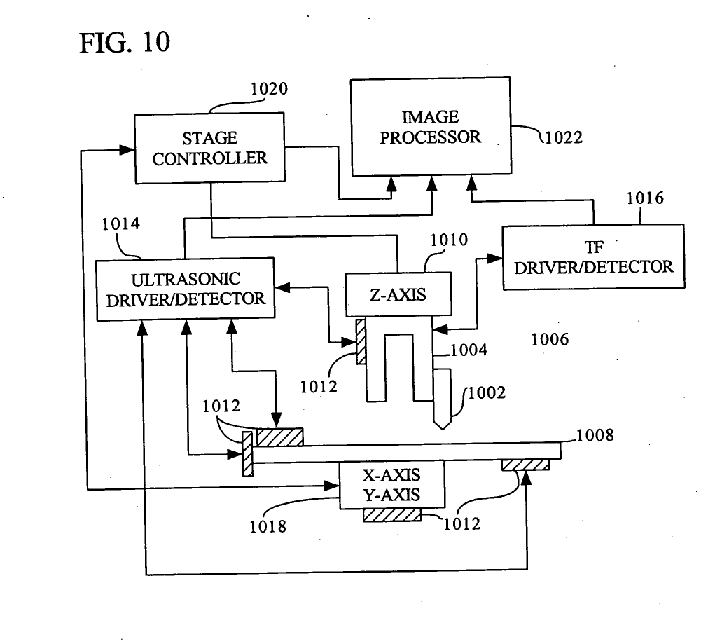

An additional representative example is illustrated in FIG. 10. A probe 1002 is coupled to a tuning fork 1004 that is configured to be moved toward or away from a specimen 1008 with a z-axis stage 1010. Ultrasonic transducers 1012 are provided at a variety of locations, and are coupled to a driver/detector 1014 so that one or more of the ultrasonic transducers can be used to produce or detect acoustic waves. A TF driver/detector 1016 is similarly configured to produce or detect acoustic waves. The specimen 1008 can be scanned with an XY-stage 1018 under the control of a stage controller 1020. Detected signals and position data from the stage controller 1020 are delivered to an image processor 1022 that produces specimen images. Typically, the ultrasonic transducers are piezoelectric devices, but other acoustic generators/detectors can be used. In addition, as shown in FIG. 10, the tuning fork 1004 is oriented to that the probe tip oscillates substantially laterally with respect to the specimen surface. In other examples, the tuning fork can be tilted with respect to the sample surface to have a substantial vertical oscillation component to “tap” on the sample surface.

Accordingly, we claim as our invention all that comes within the scope and spirit of the appended claims.

We claim:

1. A scanning microscope, comprising:
a probe having a probe tip for contacting a specimen;
a probe stage configured to move the probe tip toward the specimen;
a first acoustic transducer coupled to the probe,
a second acoustic transducer adapted to be acoustically coupled to the specimen and the probe tip.

2. The scanning probe microscope of claim 1, further comprising a first transducer driver configured produce an acoustic vibration of the probe tip with the first acoustic transducer, and a first transducer detector situated to receive an electrical signal produced by the second acoustic transducer in response to the acoustic vibration of the probe tip.

3. The scanning probe microscope of claim 2, further comprising:
a translation stage configured for scanning that the probe tip with respect to a specimen surface; and
an image processor configured to receive electrical signals from the first transducer detector as the probe tip is scanned and to produce an image of a specimen surface.

4. The scanning probe microscope of claim 3, further comprising a quartz tuning fork that include the first acoustic transducer, wherein the probe tip is secured to a tine of the tuning fork.

5. The scanning probe microscope of claim 4, wherein the first transducer detector is configured to detect probe tip vibration based on an assessment of a tuning fork vibration amplitude.

6. The scanning probe microscope of claim 4, wherein the first transducer detector is configured to detect probe tip vibration based on an assessment of a tuning fork admittance.

7. The scanning probe microscope of claim 4, wherein the first transducer detector is configured to detect probe tip vibration based on an assessment of a frequency associated with a maximum amplitude of a tuning fork vibration.

8. The scanning probe microscope of claim 1, further comprising a first transducer driver configured produce an acoustic vibration of the specimen with the second acoustic transducer, and a first transducer detector situated to receive an electrical signal produced by the first acoustic transducer in response to the acoustic vibration of the specimen.

9. The scanning probe microscope of claim 8, further comprising:
a translation stage configured for scanning that the probe tip with respect to a specimen surface; and
an image processor configured to receive electrical signals from the first transducer detector as the probe tip is scanned and to produce an image of a specimen surface.

10. The scanning probe microscope of claim 9, further comprising a quartz tuning fork that include the first acoustic transducer, wherein the probe tip is secured to a tine of the tuning fork.

11. The scanning probe microscope of claim 10, wherein the first transducer detector is configured to detect probe tip vibration based on an assessment of a tuning fork vibration amplitude.

12. The scanning probe microscope of claim 10, wherein the first transducer detector is configured to detect probe tip vibration based on an assessment of a tuning fork admittance.

13. The scanning probe microscope of claim 10, wherein the first transducer detector is configured to detect probe tip vibration based on an assessment of a frequency associated with a maximum amplitude of a tuning fork vibration.

14. A method, comprising:
scanning a probe tip over a specimen surface;
applying an acoustic signal to the specimen;
coupling the acoustic signal between the specimen and the probe tip;
detecting the coupled acoustic signal; and
forming an image based on the detected coupled acoustic signal.

15. The method of claim 14, wherein the acoustic signal is applied to the specimen with a transducer that is secured to the probe tip.

16. The method of claim 14, further comprising detecting the coupled acoustic signal with an acoustic transducer that is secured to the probe tip.

17. The method of claim 14, wherein the acoustic signal is a applied to the specimen with a transducer that is secured to the specimen.

18. A method, comprising:
applying an acoustic signal to a probe tip;
determining a probe tip distance from a specimen surface for which the acoustic signal at the probe tip is substantially unchanged and for which an acoustic signal coupled between the specimen and the probe tip is detected.

19. An apparatus, comprising:
a tuning fork;
a probe secured to the tuning fork;
an acoustic transducer acoustically coupled to a specimen;
an probe driver electrically coupled to the tuning fork and configured to produce an oscillation of the tuning fork;
a positioner configured to move the probe towards a specimen; and
a signal processor configured to detect an acoustic signal received by the acoustic transducer in response to the tuning fork oscillation.

20. The apparatus of claim 19, wherein the signal processor is configure to estimate a characteristic of the tuning fork oscillation, wherein the characteristic is selected from a group consisting of resonance frequency, admittance, or quality factor.
